(19) United States
(12) Patent Application Publication
(10) Pub. No.: US 2013/0318160 A1
(43) Pub. Date: Nov. 28, 2013

(54) Device and Method for Sharing Data and Applications in Peer-to-Peer Computing Environment

(71) Applicants: Mutaz Seleam Beraka, Riyadh (SA); Sofien Gannouni, Riyadh (SA); Hassan Mathkour, Riyadh (SA)

(72) Inventors: Mutaz Seleam Beraka, Riyadh (SA); Sofien Gannouni, Riyadh (SA); Hassan Mathkour, Riyadh (SA)

(21) Appl. No.: 13/481,954

(22) Filed: May 28, 2012

(51) Int. Cl. G06F 15/16

(52) U.S. Cl. 709/204

(57) ABSTRACT

The current invention provides a simple yet efficient Data Service Middleware or DSM computing device and method that provides access to remote, heterogeneous and autonomous peer-to-peer (P2P) data sources, thereby allows users to share and exchange files. The current invention allows non-expert users to share and integrate their data and can meet the growing need of sharing existing widespread data-sources. In the current invention data sources are exported and deployed as services and as such, data sources easily discovered and uniformly accessible using standard SOAP requests and are integrated through service composition.

### BACKGROUND TO THE INVENTION

Sharing and integrating existing autonomous, distributed and heterogeneous data sources allow companies and individuals to gain a holistic understanding of data. They have been recognized as of a great importance to small and huge-scale businesses. Enhancing the accessibility and the reusability of these data entail the development of new approaches for data sharing. In the literature, different data sharing approaches have been investigated and applied in different computing environments. These approaches vary in terms of concepts and technology standards. The most widely known data sharing approaches are: transaction processing monitor, tuplespace, resource description framework, and data service layer (DSL).

Service-oriented computing has emerged as the eminent distributed computing model for developing reusable loosely coupled service-centric business applications. DSL provides a uniform view of the data in an SOA-based system. It is responsible for accessing structured, semi-structured and un-structured data sources using Web services or representational state transfer (REST) style Web services. The main advantage of this approach is that it reduces the complexity of developing new applications that integrate data from several data sources.

As the data service layer is a key factor for a successful development of SOA-based systems, various DSL propose different mechanisms for achieving efficient data access. Most of the existing DSLs are dedicated for single site users and do not satisfy the need of users to access efficiently data at different locations. Some prototypes develop solutions for efficient distributed data access, but they do not consider their users as peers. Implementations of DSL prototypes for Peer to Peer (P2P) computing environment are rare and almost nonexistent. In addition, existing systems do not provide a comprehensive and complete solution for P2P data sharing.

When we are looking back at the computer industry, we can clearly identify the growing need of data sources in small and large scale business. As per a recent survey done by the Ponemon Institute, 90 percent of organizations reported having more than 100 databases and 23 percent have more than a 1,000. This massive presence of databases in these organizations is due to the fact that many of the employees of these organizations have created their own “databases” in response to the requirement of the tasks they are responsible for. These people require often integrating and sharing their data sources to gain the holistic understanding of the whole organization's data.

The underpinning for an organization's use of the proposed approach is the ability to discover existing data sources, to have a uniform access to the data sources and to save time in the development of new business applications by enabling the integration of existing data sources through service composition. reported that up to 70 percent of the time spent to develop applications that integrate data from different data sources is consecrate to accessing distributed data.

During the last decade, much research and development effort has been put into proposed approaches for accessing remote, heterogeneous and autonomous data sources. In our review of the literature, we identify the following four approaches: Transaction Processing Monitors, Tuplespace, Resource Description Framework and Data Service.

Transaction Processing Monitors or TPM provides an infrastructure for building and administering complex transaction processing systems with a large number of clients and multiple servers. It supports mainly services for submitting user queries, routing them through servers for processing, coordinating the two-phase commit when the transactions are running over multiple servers and ensuring that each transaction satisfies the Atomicity, Consistency, Isolation, Durability (ACID) prosperities. These properties guarantee the database's consistency over time and guard against hardware and software errors.

Tuplespace was initially proposed to support the Linda parallel programming language which was developed by David Gelernter and Nicholas Carriero at Yale University. It provides a set of primitive operations to insert, fetch and retrieve data from a shared space that stores user data. It may be considered a form of distributed shared memory which allows the data providers to post their data as tuples in the shared space, and the data consumers to fetch and retrieve data which matches a certain pattern from that space.

Resource Description Framework or RDF is a Semantic Web technology that supports the exchange of data and knowledge on the Web. It is a standard format developed by W3C for representing and storing any kind of data as Web resources on the Web. In practice, RDF resources are identified by Uniform Resource Identifiers or URIs on the Web. This URI reference is formed by a URI namespace and a local name.

The Data Service Approach is the most widely used approach nowadays for data exchange. It embodies the Service-Oriented Architecture or SOA principles to expose data stored in heterogeneous and autonomous data sources. It supplies a Data Service Layer or DSL as a mechanism for masking heterogeneity between data sources such as databases, files or spreadsheets, and make them available as Web services or as set of Representational State Transfer (REST) style Web services. The main advantage of this approach is that it reduces the complexity of developing new applications that integrate data from several data sources.

### SUMMARY OF THE INVENTION

The current invention provides a simple yet efficient Data Service Middleware or DSM computing device and method that provides access to remote, heterogeneous and autonomous data sources peer-to-peer (P2P) data sources, thereby allows users to share and exchange files. The current invention allows non-expert users to share and integrate their data and can meet the growing need of sharing existing widespread data-sources. In the current invention data sources are exported and deployed as services. As such, data sources easily discovered, uniformly accessible using standard SOAP requests and are integrated through service composition.

As a result the current invention is a simple yet efficient device and method that provides access to heterogeneous data sources. One embodiment of the current invention exports Databases, Excel files, XML files, CSV files as Services as a possibility to tackle data sharing and integration problems. Furthermore, an alternative embodiment of the current invention proposes an infrastructure that allows peers to customize, compose, and deploy complex data sources.

Furthermore the objectives of the current invention are to make data sharing easy and more convenient by satisfying the following sub-objectives:

Reducing the complexity of sharing existent data. This is ensured by defining a set of well defined, ready-made and easy to use services which allow the data sharing among the users. Relying on these services, the users will be able to publish their own data, discover and use those of others.

Allowing naive (with no experience) users to participate in the data sharing environment. The users sharing data with each others are considered as peers and as such they are composed of two components: Data-provider and Data-consumer. The Data-provider component will use encompasses the set of services that will automatically publish and advertize the user's data. However, the Data-consumer component will be responsible for discovering and accessing the data of the other users.

Masking heterogeneity between the available data sources and users. Because users are running on heterogeneous platforms and are sharing data in different formats, we satisfy this objective by implementing the middleware using a standard platform-independent technology (Web-services technology) and handle the shared data in XML format. So the heterogeneity that exists between the platforms and between data formats is hidden; and the interoperability between the users is increased.

Allowing service consumer and service provider to communicate with each other's without considering the heterogeneity between them.

Enabling virtual data integration through service composition.

The current invention exports every data source as a Web-service, called a Data-service, which contains a set operations (capabilities) generated based on the analysis of the data source schema. The invocation of the operations of a Data-service will lead to the execution of appropriate data manipulation statements on the corresponding data source. In order to highlight the benefits of this approach, we discuss the following motivation sample.

Let's consider three data sources namely a beekeeping database or BK, a fauna and flora data source or FF and a climatic data source or CL. The BK data source contains information about hives and bee colonies (health, species, apiaries production, etc.). The FF data source provides information about the different types of vegetation of various regions. The CL data source provides information about climatic prediction (temperature, humidity, etc.). Exporting these data sources as Data-services will provide uniform access to the data they store. Thus, the heterogeneity and the location of the data sources become transparent to the users and retrieving data from these data sources becomes a simple invocation of the operations of the Data-services. Moreover, the integration of the existing heterogeneous data sources could be obtained simply through service composition. Indeed, a beekeeper may compose new Data-service that aggregates capabilities of the BK's corresponding Data-service and capabilities of the FF's corresponding Data-service. The composite Data-service allows the beekeeper to optimize his production by identifying areas of overgrazing with potential seasonal bee flora interest. The beekeeper may also compose a new Data-service that aggregates capabilities of BK, FF and CL data sources' corresponding Data-services. The new composite Data-service provides useful data that would help beekeeper in (dis) placement of hives according to Botanico-climatic conditions of the moment.

### BRIEF DESCRIPTION OF THE DRAWINGS

FIG. 1 is a diagram of the architecture of an embodiment of the Data Service Middleware or DSM 100.

FIG. 2 is a class diagram of the architecture of an embodiment of the Data Service Layer or DSL 119.

FIG. 3 is a class diagram of the architecture of an embodiment of the Data Provider or DP 109.

FIG. 4 is a class diagram of the architecture of an embodiment of the UDDI Registry Client 117.

FIG. 5 is a class diagram of the architecture of an embodiment of the SOAP Msg. Handler or SMH 115.

FIG. 6 is a class diagram of the architecture of an embodiment of the Data Discovery or DD 113.

FIG. 7 is a class diagram of the architecture of an embodiment of the Data Consumer or DC 107.

FIG. 8 is a class diagram of the architecture of an embodiment of the Data Service Composition Engine or DSCE 111.

FIG. 9 is a class diagram of the SOAP Handler system of an embodiment the current invention.

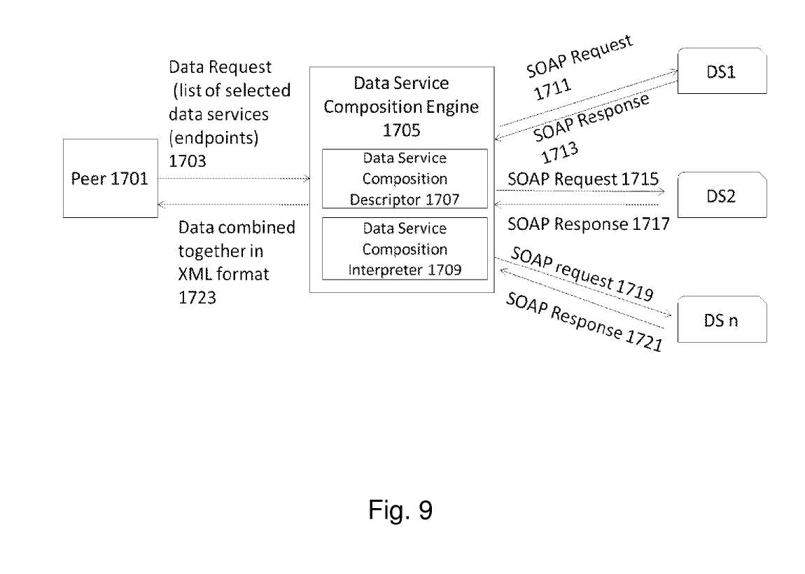

### DETAILED DESCRIPTION OF THE INVENTION

One embodiment of the current invention is a Data Service Middleware or DSM 100 that provides a Service-Oriented Middleware that embodies the principles of Service Oriented Architecture or SOA for sharing data in a P2P environment. The current invention allows peers to export their data as services and to have access to those of others using the data services they publish. The current invention provides a set of rich and easy to use services allowing non-expert users to share their data with each other. Moreover, the current invention offers a semi-dynamic service composition engine allowing users to integrate data from different resources by composing new data services. This type of service composition enables virtual data integration.

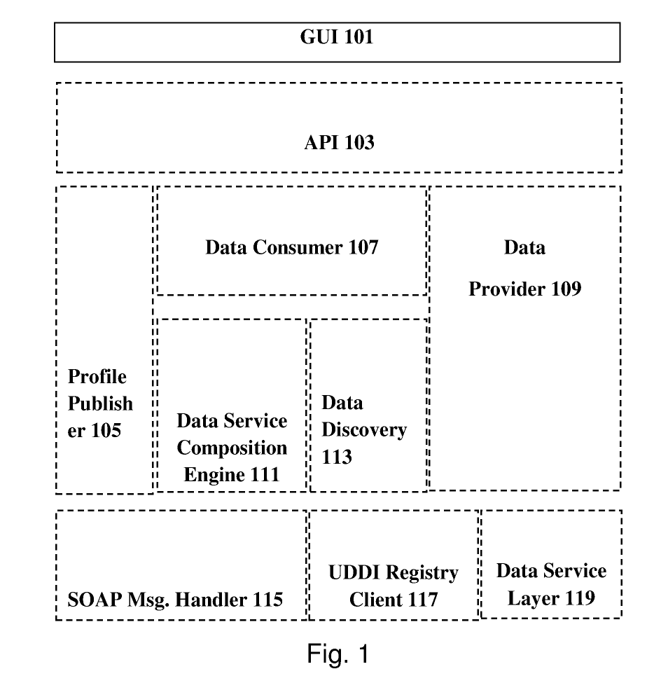

As shown in FIG. 1, the main architecture of an embodiment of current invention has the following components:
Graphical User Interface or GUI 101 for end users.
Application Programming Interface or API 103, a generic interface which allows programmers to develop new data sharing applications based on DSM.
Profile Publisher or PP 105 responsible for creating and updating the profile of a peer. Only users having profiles are allowed to publish and/or use data services.
Data Provider or DP 109 responsible for exposing or exporting users' data sources as data services and publishing them in a UDDI registry.
Data Discovery or DD 113 responsible for discovering data services based on user's search criteria.
Data Consumer or DC 107 responsible for invoking the discovered data-services which provide access to their corresponding back-end remote data sources.
Data Service Layer or DSL 119 responsible for providing access to the local data sources (excel files, XML data, relational databases, etc.).
Data Service Composition Engine or DSCE 111 responsible for generating and describing a new business process that integrates existing endpoints into a new endpoint. It is also responsible for interpreting the business logic of the process to get the XML result of the invocation.
UDDI Registry Client 117 providing access to basic UDDI functionalities.
SOAP Msg. Handler or SMH 115 is responsible for reading and writing SOAP messages, sending and receiving these messages. Moreover, it is responsible for parsing SOAP XML responses to extract embedded data.

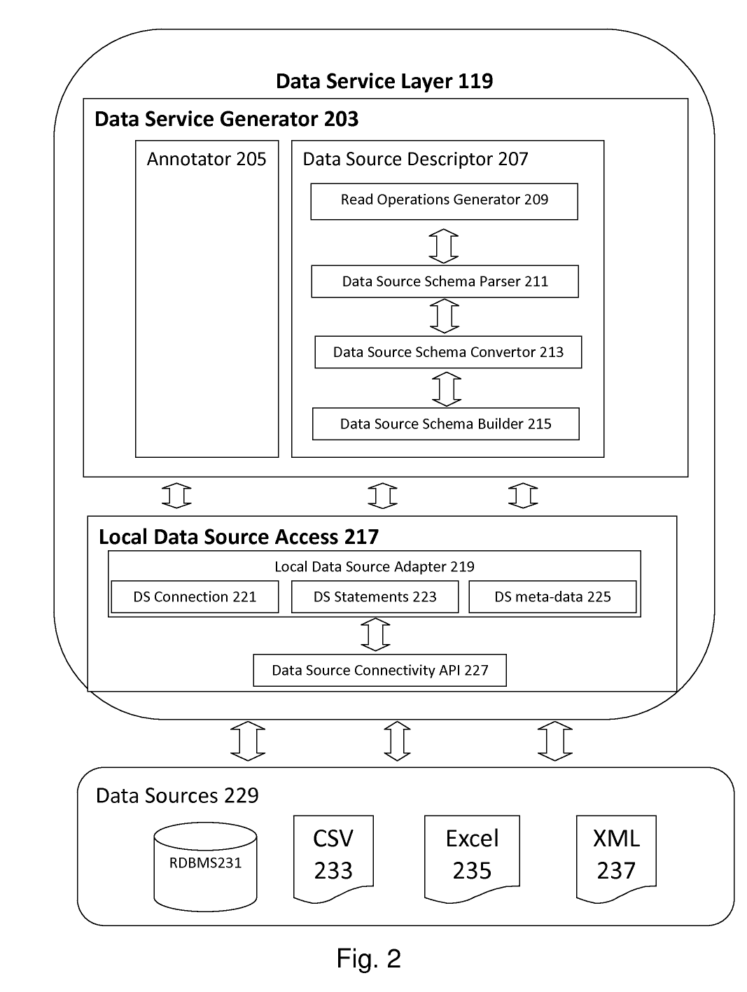

The Data Service Layer 119 allows exporting user's data sources, in whole or in part. It generates new data-services based on the scheme of the user's data sources. It preserves the local data sources' autonomy of design, association and execution. As depicted in FIG. 2, the Data Service Layer or DSL 119 consists of the three following sub-components:
Local Data Source Access or LDSAccess 217 responsible for providing uniform access to heterogeneous data sources. It allows discovering the metadata of the user's data sources and retrieving data from them.
Local Data Source Adapter or LDSAdapter 219 responsible for translating the meta-data discovery requests and the data retrieve queries submitted by the LDSAccess into statements appropriate to the local data sources.
Data Service Generator or DSG 203 responsible for generating a new data-service based on the schema of the user's data source. Firstly, the DSG 203 translates the data source's schema into an XML format. Next, the DSG 203 parses the XML format of the schema and generates a Java class which contains a set of appropriate operations that provide access to the data source tables and columns. Finally, the DSG 203 uses Web services and EJB annotations to annotate the generated Java class.

A Data Source Descriptor or DSD 207 is responsible for retrieving the schema of data source using local data source access layer, excluding tables or/and columns from schema of data source, converting it in an agreed XML format and parsing XML schema of data source to retrieve each table with list of columns to generate all read operations for this table. The Data Source Descriptor or DSD 207 consists of the following sub-components in order to complete the whole task:

A Data Source Schema Builder or DSSB 215 is responsible for establishing connection with data source by using LDSA to retrieve and build the schema. This schema contains the tables of data source, list of columns of each table and list of properties of each column which are column name, column data type, column size.

A Data Source Schema Converter or DSSC 213 is responsible for converting unstructured schema of data source which was built by DSSB into a predefined XML format of data source.

A Data Source Schema Parser or DSSP 211 is responsible for parsing the XML schema of a data source to retrieve data source name, tables and columns. Each parsed table contains table name, primary key of this table and list of columns, where each column provides this information: column name, data type, size and nullable or non nullable value.

A Read Operations Generator or ROG 209 is responsible for generating all read operations for each parsed table alone. This Generated read operations describes the whole data source, which are available to remote invocation allowing peers to retrieve data from this data source.

The Annotator 205 uses Web service and EJB annotations to annotate data service class (Java class of data source) generated by the DSG 203 and annotate Java method with their parameters to become Web service method.

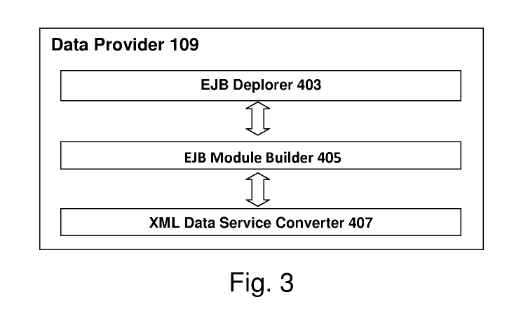

FIG. 3 describes the class diagram of the Data Provider or DP 401 which is responsible for deploying the data service generated by the DSL under the application server and publishing its description in a UDDI registry. The DP 401 performs the following tasks to expose a data source as a data service:
1. Calls the DSL adapter to create a new data service class that describes the data source.
2. Prepares XML data-service descriptor which contains information about the generated data service such as the service name, its description and useful binding information.
3. Generates a new EJB module which includes the necessary files and artifacts for this service.
4. Deploys the generated EJB module under the application server.
5. Publishes the data service through the UDDI registry using the UDDI registry client.
6. Writes information about the status of the deployment and publishing processes into a log file.

As shown in FIG. 3, an embodiment of the Data Provider or DP 109 has the following three sub-components:
XML Data Service Converter 407 responsible for converting unstructured information into an agreed XML format. This format allows other components to parse data easily in a structured manner.
EJB Module Builder 405 responsible for generating a new EJB module with the necessary files and artifacts.
EJB Deplorer 403 responsible for deploying (un-deploying) the generated EJB module under the application server using Ant-API.

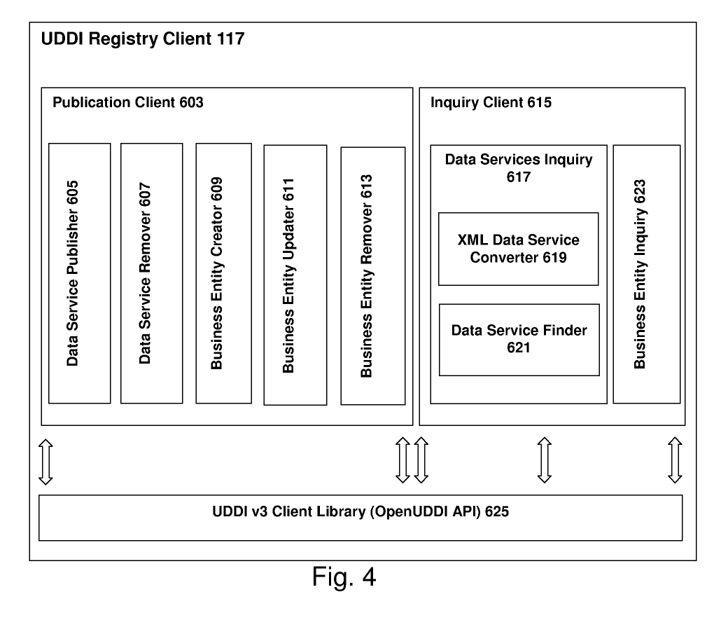

As shown in FIG. 4, the UDDI Registry Client or URC 117 is responsible for accessing any UDDI v3 compliant server 625 using a valid security token (publisher profile). It allows peers to use their publisher profiles (username and password) to create, update and delete business entities, to publish and/or remove data services under a specific business entity, and to discover data services that are published by other peers.

The UDDI Registry Client or URC 117 consists of two main components that are shown in FIG. 4. One main component of the UDDI Registry Client or URC 117 is the Publication Client 603 is responsible for performing publication operations on UDDI registry using valid security token. Some of the examples of these operations are changing the business entity name, publishing new data service and removing data service. The Publication Client 603 consists of five sub-components:
A Data Service Publisher 605 is responsible for publishing a new data service under specific business entity using valid security token;
A Data Service Remover 607 responsible for removing published data service from UDDI registry using valid security token;
A Business Entity Creator 609 responsible for creating a new business entity associated to publisher in UDDI registry using valid security token;
A Business Entity Updater 611 responsible for updating the existing business entities using valid security token. It allows the publisher to modify business entity information such as change the name, the contact information, etc.; and
A Business Entity Remover 613 responsible for removing business entity from the UDDI registry using valid security token.

The other main component of the UDDI Registry Client or URC 117 is the Inquiry Client 615 which is responsible for retrieving information about business entities and data services using valid security token. The Inquiry Client 615 consists of two sub-components, the Data Service Inquiry 617 and the Business Entity Inquiry 623.

The Data Service Inquiry 617 is responsible for inquiring about already published data services according to search criterion using valid security token. As shown in FIG. 4, the Data Service Inquiry 617 consists of the following sub-components:
A Data Service Finder 621 responsible for finding matched data services from UDDI registry according to selected search criterion; and
A XML Data Service Converter 619 responsible for converting information of discovered data services such as data service name, description, URL of WSDL file in an agreed XML format for data services.

The Business Entity Inquiry 623 is responsible for inquiring about business entities stored in UDDI registry using valid security token. If the result of searching is found then it may return list of business entities of the peer.

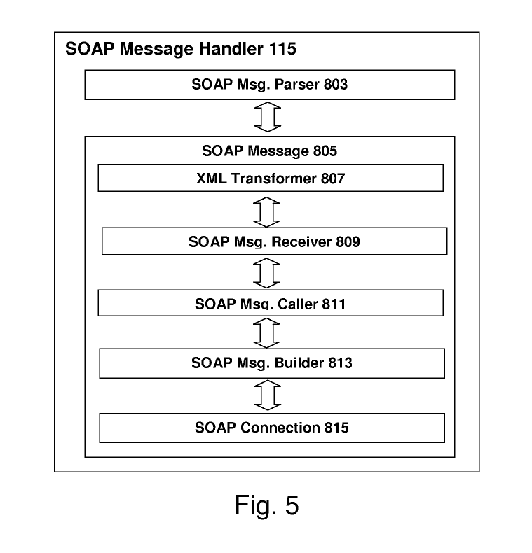

As shown in FIG. 5 the SOAP Message Handler or SMH 115 is responsible for reading and writing SOAP messages. It sends and receives these messages through the Internet using SOAP with Attachments API for Java (SAAJ). Moreover, it parses SOAP XML responses to extract data.

In FIG. 5 the SOAP Message Handler or SMH 115 consists of two sub-components, the SOAP Message 805 and the SOAP Message Parser 803.

Further the SOAP Message 805 consists of the following components:
SOAP Connection 815 responsible for establishing a connection with specific endpoint to send SOAP message request and receive SOAP response message through it;
SOAP Msg. Builder 813 responsible for creating a new SOAP message with the default SOAP Part, SOAP Envelope, SOAP Body and SOAP Header objects; Additional data could be added to the SOAP message by filling required parts with appropriate data based on endpoint information and endpoint's target method;
SOAP Msg. Caller 811 responsible for calling specific endpoint to send SOAP message request. This component uses the established connection by “SOAP Connection component” to send and receive SOAP messages;
SOAP Msg. Receiver 809 responsible for receiving SOAP response message from the caller component; and
XML Transformer 807 responsible for transforming XML content of SOAP message to an appropriate stream such as OutputStream, StringBuffer, etc.

The SOAP Msg. Parser 803 component is responsible for parsing SOAP message responses to extract the result from the SOAP message body.

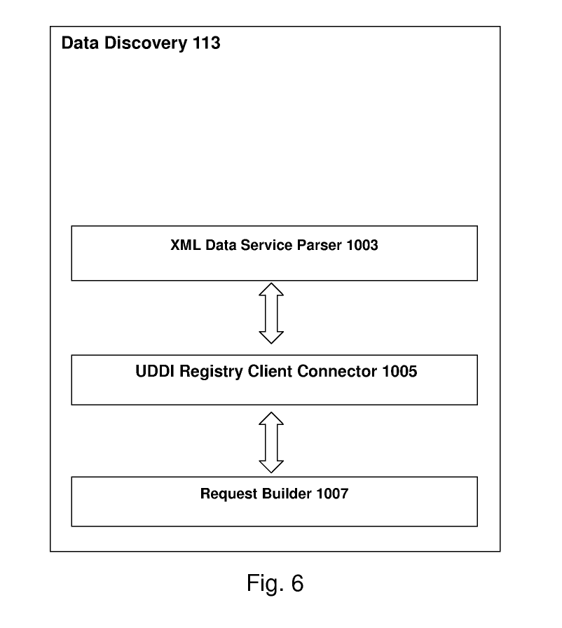

As shown in FIG. 6 the Data Discovery or DD 113 is responsible for discovering the data-services published by the other peers. The DD 113 uses the UDDI registry client to retrieve the data services' descriptors according to the user's criteria and values.

As shown in FIG. 6, the DD 113 consists of the following three sub-components:
A Request Builder 1007 responsible for building a search request based on the user's criteria and querying the data services repository (UDDI Registry) using URC. The result is a list of XML data-services' descriptors;
A UDDI Registry Client Connector 1005 responsible for sending the request to the UDDI Registry Client and for receiving the result; and
An XML Data Service Parser 1003 responsible for parsing the XML data-services' descriptors to retrieve the information about each data service, such as the name, the description and the URL of the WSDL document.

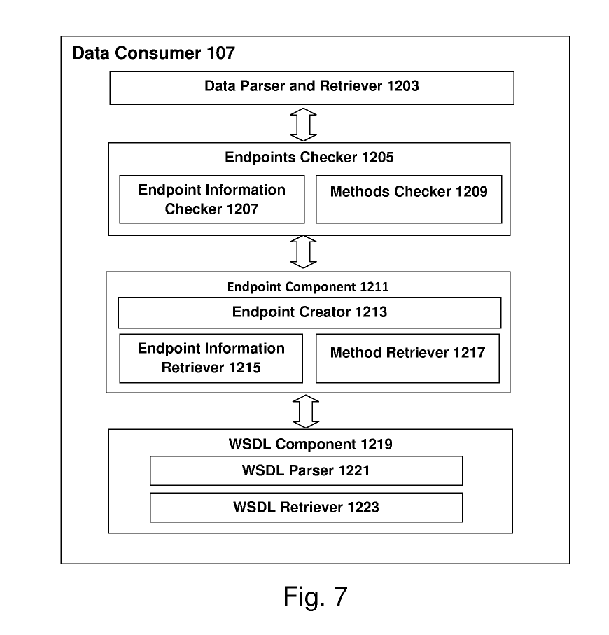

As shown in FIG. 7 the Data Consumer or DC 107 is responsible for enabling access to the back-end remote data sources through the invocation of the operations of the published data-services. Firstly, DC 107 defines and submits the user's search criteria to the Data Discovery 113. The DC 107 receives back and parses the result of the discovery phase. Further, the DC 107 allows the user to specify the operations to invoke and adds them to a remote invocation list. Finally, the DC 107 passes this latter list to the data service composition engine for processing and parses the result returned back. DC parses the XML results and returns back the data to the user.

As shown in FIG. 7, the Architecture of Data Consumer or DC 107 consists of the following components:
WSDL Component 1219: It is responsible for retrieving and parsing the WSDL (data-service descriptor) document associated to the data service;
Endpoint Component 1211: This is responsible for extracting useful information from the parsed document and for creating a new endpoint object;
Endpoint Checker 1205: It is responsible for checking the completion and the correctness of the information on an endpoint as well as the correctness of selected methods; and
Data Parser and Retriever 1203: This is responsible for parsing the XML results returned back by the DSCE engine.

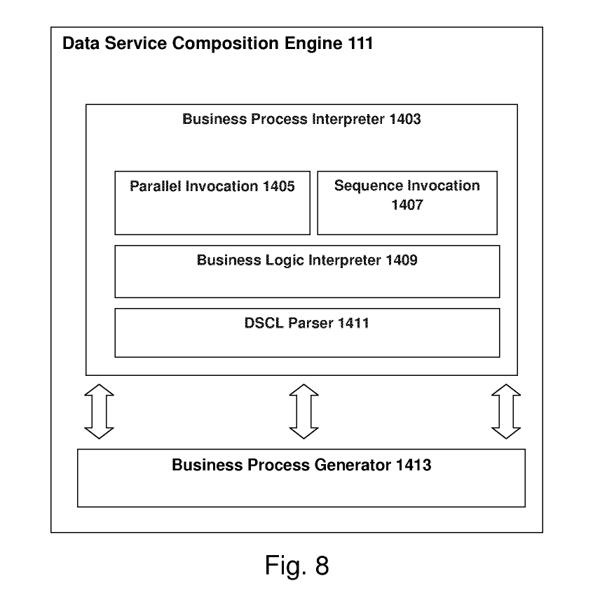

As shown in FIG. 8 the Data-Service Composition Engine or DSCE 111 is responsible for composing new data-services from capabilities (operations) of existing data-services by providing a description of their corresponding business process. It is also responsible for parsing, interpreting and supplying the result of a business process description.

As described in FIG. 8, the DSCE 111 consists of the two main components: a Business Process Generator or BPG 1413 and Business Process Interpreter or BPI 1403. The Business Process Generator or BPG 1413 is responsible for composing a new data-service as an aggregation of a set of existing data services. It generates for the composite data-service a new business process, written in Data-Service Composition Language (DSCL) which is derived from BPEL, based on the list of selected endpoints, target methods within these endpoints, execution constraints and invocation options.

The Business Process Interpreter or BPI 1403 is responsible for parsing, interpreting and executing the logic of a DSCL business process to perform remote method invocation sequentially or in parallel based on the execution mode and activities precedence graph.

Further the BPI 1403 consists of the following sub-components:
DSCL Parser 1411: It is responsible for parsing the XML description of a DSCL business process to extract useful information about the business process. It doesn't supply information on the logic of the business process. Based on the extracted information, it creates a process information object.
Business Logic Interpreter 1409: It is responsible for interpreting and executing the logic of the business process. This component uses the process information object generated by the parser to get the required information to perform the invoke activity such the method name, input parameters, output parameters and messages of that method.
Sequential Invocation 1407: It is offers the ability to perform a set of invocation activities of a business process in a sequential mode.
Parallel Invocation 1405: It provides the ability to perform a set of invocation activities of a business process in a parallel manner using the Fork-Join capabilities of Java.

The Profile Publisher or PP 105 is an authentication system to enforce proper access to the UDDI registry and prevent it from non-authorized access, which is a Web service integrated with jUDDI. We implement a suitable authentication mechanism that meets our requirement of having a valid authentication token for each request sent to jUDDI. Obtaining this token requires the correct credentials. However, the Profile Publisher 105 is a Web-service client that is responsible for performing the following operations:
Register a new peer in the UDDI registry by creating a new profile.
Check that the credentials of the peer profile publisher are correct before allowing the peer to perform operations such as publishing and inquiring.
Modify profile information such as the password and email or IP address.

The data exchange formats in the DSM 100 are agreed XML formats that are allowing components of DSM to exchange organized data with each other. Also data which is retrieved from invocation should be in XML format to allow the consumer handles it by parsing XML document to extract data. These XML format helps to avoid working with un-structure data, conflicts in implementation of components, custom code and memorizes how we wrote the data.

In the DSM 100, there are three types of data; each one will be converted into specific agreed XML format. These XML formats are as follows:

### 1. XML Format for Schema of Data Source

This XML format is agreed XML format which is specific for converting schema (metadata) of data source into XML format. The XML document allows other components to parse it so as to extract information in structure-manner.
2. XML Format for the Result of Select Query from Data Source
This XML format is agreed XML format which is specific for converting data retrieved from data source into XML format after applying select query.

### 3. XML Format for Data Services

This XML format is agreed XML format which is specific for converting information of data service or more than one data service into XML format. This XML format is suitable for expressing deployed information of data service allowing DP to parse it so as to extract the information of data service to deploy it under application server, and expressing information of discovered data services allowing DC to parse it so as to extract information of data services.

### Service Composition in DSM

Web services composition is a process-oriented approach to SOA for relatively simple descriptions of how Web services should be composed into business processes. Our language for Web services composition named Data Services Composition Language or DSCL. The DSCL benefits from static model of service composition especially from the BPEL language to propose an XML-based standard for describing business process. So, it is a BPEL light to support automation of compositing data services from a set of services which are selected by a peer. Beside the DSCL, DSM provides data service composition engine named DSCE which is responsible for parsing DSCL grammar and interpreting the internal business logic of DSCL description to retrieve the result of invocation in an agreed XML format.

Characteristics of Data Service Composition in DSM
Invoke more than one data services per request
   Provides scalability and adaptability required in sharing data.
Dynamic and flexible service composition
Provides a clear separation between the composition logic and the data services used.
Provides the ability to combine data services to retrieve data from different data sources.
Semi-automation support, because the peer doesn't need to specify partner links, services and other elements at design time, it works automatically once the user passes the list of selected services with related information that he wants to invoke them.
Data services do not share any input with each other's.
There are no dependencies between data services; it's fully loosely-coupled.
This feature allows reducing the execution time of the whole business process by running different data services in parallel way.
Standard compliant
Interaction with data services is done through WSDL interfaces and uses SOAP messages to exchange data.
All data and information exchanged inside components of DSM and outside DSM is XML data.

### Data Service Composition Language or DSCL

DSCL automates the process to coordinate and compose a set of data services (Web services) across a single business process. It doesn't need to specify partners and services at design time, just provides a list of endpoints which contain information and methods and got a result of invocation in agreed XML format. Also, it provides two options for execution business process. The first option is interpreting and executing activities of business process in sequential way. The second option is interpreting and executing activities of business process in parallel way.

DSCL is based on two other's XML standards allowing Web services interaction: WSDL standard and SOAP standard. The WSDL standard describes the interface of Web service (methods, messages and more information). So DSCL uses WSDL documents of Web service (data service) providers to describe the participation of those services in a process and how services will be interacted. DSCL uses SOAP to interact with the Web services in standard manner.

The XML grammar of DSCL will be interpreted and executed by the proposed engine named Data Services Composition Engine or DSCE. The result will be represented in XML format.

Service composition in DSM allows peers to invoke one or more data services per request to pull data from multiple data sources. It is more flexible to invoke any number of services with any number of methods associated to those services. At this moment, the result of invocation will be merged together.

### Primitives

Primitive activities are used to define a simple business process. These activities can be used with structure activities to define complex business process.

TABLE 1
DSCL primitive activities

| Tag | Description |
|---|---|
| <receive> | Used to wait invocation for business process form client |
| | by sending a message. |
| <reply> | Used to generate response for synchronous operations. |
| <invoke> | Used to invoke other web services. |
| <assign> | Used to manipulate data variables in business process. |
| <AssignValue> | Used to assign value for specific parameter inside |
| | business process |
| <throw> | Used to exception handling (Not supported yet) |
| <wait> | Used to wait for some time (Not supported yet) |
| <terminate> | Used to terminate the entire business process |
| | (Not supported) |

### Structure Activities

Structure activities are used to define a complex business process by combining with primitives activities. These activities specify exactly the steps of business processes.

TABLE 2
DSCL structure activities

| Tag | Description |
|---|---|
| <sequence> | Used to define the sequence activity, which allows us to |
| | define the order of invocations for a set of activities. |
| <flow> | Used to define the parallel invocations for a set of activities. |
| <switch> | Used to case-switch construct (<switch>) for implementing |
| | branches. (Not support) |
| <while> | Used to define loop. (Not support) |
| <pick> | Used to select one of several alternative paths that meet the |
| | client needs. (Not support) |

### General Definition Form of DSCL Business Process

DSCL is an XML-based language which is used to coordinate and compose a set of data services across a single business process. It embodies orchestration approach to interpret and execute the sequence of activities in business process in sequential or parallel way.

DSCL business process will be generated automatically by DSCD inside DSCE so the peer will not be intervened in this task. The peer only provides the list of endpoints, constraints, option of operation applied on results and option of execution, and leaving the responsibility on DSCE to generate, describe, interpret and execute business process and merge the results in one result.

DSCL is behavioral extension of WSDL using layer on top of WSDL, where WSDL defines operations of specific data service and DSCL defines how operations of data services can be sequenced. DSCL focuses on executable business processes, it includes full support on control flow and data flow using primitives and structure activities.

### Development Environment

An embodiment of the DSM 100 is fully implemented in Java programming language. The different components of our DSM are developed using the following tools and APIs:
Glassfish v2.x
   It is an open source application server project led by Sun Microsystems for the Java EE platform. The proprietary version is called Oracle GlassFish Enterprise Server and free version is called Glassfish. The Glassfish is dual-licensed under two free software licenses: the Common Development and Distribution License (CDDL) and the GNU General Public License (GPL) with the classpath exception [WikipediaGlassFish]. It is free software and the best application server which supports open source community in the industry today. Glassfish may contain one or more domains, each domain hosts a number of Java J2EE applications standards deployed to it, and these standards include: Web Application Archive (WAR), Enterprise Application Archive (EAR) and Enterprise Java Bean (EJB) files. Glassfish provides full Web services stack to build and deploy Web services based on the Java API for XML Web Services (JAX-WS), JPA persistence engine (Toplink), EJB model and more [Quinn2007]. For administration and monitoring, Glassfish provides Web tool called Admin Console and command-line tool called asadmin, these two consoles provide a set of features for doing the most of administration and monitoring tasks such as deploy, un-deploy JEE applications, invoke deployed Web services thorough generated test forms and monitoring feature called Call-Flow, which reveals very accurately where time is being spent in the application before a response is sent [Alexis2008].
Apache Tomcat Server v6
   Apache Tomcat (or simply Tomcat) is an open source servlet container that developed by Apache Software Foundation (ASF). It implements Java Servlet and JavaServer Pages (JSP) technologies based on Java Servlet and JSP specifications are developed under Java Community Process (JCP), and provides a pure Java HTTP Web server environment for Java code to run [Apache Software Foundation] [WikipediaApacheTomcat2011]. Apache Tomcat must not be confused with Apache Web server, because Apache Tomcat is Java implementation of HTTP Web server, and Apache Web server is C implementation of HTTP Web server. However, Apache Tomcat and Apache web server are not bundled together. Apache Tomcat has configuration and management tools, but you can also configure it by editing XML configuration files [WikipediaApacheTomcat2011].
Apache Ant v1.8.0
   Apache Ant is Java-based open source software and command-line tool released under the Apache Software License for automating software build processes. It requires the Java platform and it's best suited to build projects of Java. Ant can also be used effectively to build non Java projects such as C or C++ applications. It provides a set of jars files that constitute an Ant API allowing Java developers for creating and manipulating a new XML build files or working on existing XML build file to manipulate and/or execute targets in this file [Apache Ant Project2010].

Apache Ant API provides all functionalities of Ant to Java application programmatically [Apache Ant Project2010]. It uses XML to describe build process and its dependencies that are described in terms of targets and tasks. By default, the name of XML build file is build.xml. Each build file contains one project and at least one target, each target contain one or more tasks. However, Ant API is very flexible and doesn't require conventions or directory layouts to the Java projects which adopt it as build tool.
Microsoft SQL Server JDBC Driver (Sqljdbc) v3.0
   It is JDBC driver (API) for using with SQL server [MS SQL Server Driver]. It is free driver, which is available for all users of SQL Server without any additional charge to provide accessing to SQL Server 2008 R2, SQL Server 2008, SQL Server 2005 or SQL Server 2000 from any Java application, application server such as IBM WebSphere and Java-enabled applet [MS SQL Server Driver]. This driver provides database connectivity through the JDBC APIs available in Java Platform [MS SQL Server Driver].
MySQL Connector/J v.5.1.13
   MySQL Connector for Java is the official JDBC driver (API) for using with MySQL database[MySQL driver]. It provides access to MySQL database from any Java application, application server such as Glassfish server and Java-enabled applet [MySQL driver]. This driver provides database connectivity through the JDBC APIs. In other words, it converts JDBC calls into network protocol used by the MySQL database [MySQL driver].
Derby Network Client API v.10.6.1.0
   It is providing network connectivity to the Derby Network Server. It is typing for JDBC compliant driver to use with Derby Network Server to attempt to match the Embedded JDBC driver of Derby as much as possible [Apache Derby]. The connections with Derby Network Server establish via JDBC URL [Apache Derby].
Java API for XML Web Services (JAX-WS)
   JAX-WS is a Java API designed to take the place of Java API for XML-based RPC (JAX-RPC) for creating and building Web applications and Web services. The change of name reflected the move from RPC-style to document style for Web service [Wikipedia JAX-WS2011]. It uses annotation to simplify the development and deployment Web services and Web services clients [Wikipedia JAX-WS2011]. It uses to build Web service corresponding clients that communicate using XML to send SOAP messages or use remote invocation to exchange data between client and provider of Web service. JAX-WS includes three Java APIs: JAX-WS (javax.xml.ws), SAAJ (javax.xml.soap) and Web services metadata (javax.jws). SAAJ API conforms to the SOAP 1.1 and 1.2 with attachments specifications, it allows reading and writing SOAP messages, also sending and receiving such messages over the Internet. Web services metadata API is using to annotate Java classes to define theses classes as Web service endpoints [Wikipedia JAX-WS2011] [Eckstein 2006]. Reference implementation of JAX-WS (JAX-WS RI) is developed as open source project and is part of Glassfish project to be production and quality implementation. This JAX-WS RI is now a part of Metro distribution [Wikipedia JAX-WS2011].
Java API for XML Processing (JAXP)
   JAXP is a Java API for creating, representing and manipulating a new XML document programmatically or parsing, transforming and validating existing XML documents independent of particular XML processor implementation. JAXP provides a pulggability layer that allows vendors to develop their own implementation without introducing dependencies in code of application [J2EE Tutorial]. JAXP provides three parser standards: Document Object Model (DOM), Simple API for XML (SAX) and Streaming API for XML (StAX) [McLaughlin 2007].
   DOM standard uses tree-based technique to parse entire XML document and construct complete in-memory document representation using concepts of classes modeling found in DOM Level 2 Core Specification. SAX standard is opposite of DOM, because it doesn't create in-memory representation of the XML document to solves memory problem. It uses event-based technique with push-based approach for informing clients the structure of XML document by invoking callback methods in handler. With SAX standard, you must go to the end of document and the caller must be ready to handle all events on one shot when parsing XML document. StAX standard is taking place between DOM and SAX standards. It uses pull-based approach to move from one item to another in XML document by providing the programmatic entry point within this document. It exposes methods for iterative and event-based XML documents processing. However, StAX provides two distinct APIs for reading and writing XML documents. Iterator API represents a stream for XML document as a set of discrete objects of event. The two interfaces for Iterator API are XMLEventReader for reading XML document and XMLEventWriter for writing XML document. The other API is Cursor API, which represents a cursor to walk through XML document from start to end. It points to one item at a time and goes forward and never backward. The two interfaces for Cursor API are XMLStreamReader for reading XML document and XMLStreamWriter for writing XML document.
   In simple comparison between DOM, SAX and StAX, the DOM and StAX support writing and parsing XML documents unlike SAX where it's parser only. JAXP provides namespace support for working with DTDs. JAXP also provides XML Stylesheet Language Transformation (XSLT) standard for transformation XML document into other forms of data such as String, HTML, etc. . . . [J2EE Tutorial] [Eckstein 2006] [McLaughlin 2007].
Web Service Definition Language for Java Toolkit (WSDL4J) v1.6.2
   WSDL4J is open source project on IBM developerWorks site whose purpose is to provide a reference implementation for Java Specification Request 110 (JSR 110): Java APIs for WSDL (JWSDL) [Brittenham 2001]. It provides a Java interface for creating, representation and manipulating a new WSDL document programmatically or reading and parsing existing WSDL documents [Brittenham 2001].
OpenUDDI Client API v.1.4
   OpenUDDI Client API is UDDI v3 Client API was developed by Joakim Recht and Kjeld Froberg, and sponsored by The Danish National IT and Telecom Agency. It provides a high performance and easy to access UDDI v3 complaint server though Java [Cunningham2010]. It allows UDDI v3 user (service provider) to publish services in UDDI v3 registry after obtains a valid security token by providing publisher username and password, also it allows UDDI v3 user (service consumer) looks up the particular services in registry after obtains a valid security token if required to invoke those services later on. OpenUDDI Client API has a set of features allow UDDI v3 user to add, modify and delete business entities, business services, binding templates and tModels [Brittenham2001].
Java Fork-Join Framework
   In multicore revolution, Java development team offers a new concurrency framework taking into account the possibilities of new microprocessors. Hence, JDK 7 adds support for fine-grained parallelism by offering fork-join framework that allows developers and programmers utilizing the possibility of multicore microprocessors. In contrast with threading model, this framework takes full advantages of all available cores [Hillar 2009] [Java Tutorials].
   The fork-join framework is an implementation of ExecuteService interface that helps you take advantages of multiprocessors to use all available processing power. As with any ExecuteService, this framework distributes tasks to worker threads in a thread pool and uses a work stealing algorithm. The package java.util.concurrent.forkjoin in JDK 7 release offers the following base classes [Hillar 2009]:
RecursiveAction: To represent divide-and-conquer solutions.
RecursiveTask: To represent result-bearing tasks.
AsyncAction: To work with tasks that re quire asynchronous completion, usually parent-child relationships.
CyclicAction: To work with parallel iterative tasks.
   This framework is flexible for setting (1) Sequential threshold for comparing the problem size to given threshold number to choose between sequential execution (solve problem sequential) and parallel execution (divide problem in sub-problems). (2) Number of threads in fork-join pool [Goetz]. The benefits of Work-stealing algorithm in fork-join framework occur in the following points [Goetz]:
Create a limited number of worker threads.
Each worker thread maintains a private double-ended work queue (deque).
When forking, worker pushes new task at the head of its deque.
When idle or waiting, worker pops a task off the head of its deque and executes it.
Instead of sleeping.
If worker's deque is empty, steals an element off the tail of the deque of another randomly chosen worker.
   Finally, this new framework is very useful in parallel computing for computing-intensive tasks running on multicore CPUs.

The current invention developed a novel middleware named Data Service Middleware or DSM that enables users to share their data sources in a P2P environment. It relies on a service-oriented approach to export users' data sources as data-services, discover and invoke those services. It also relies on a process-oriented approach to provide service composition capabilities in order to support virtual data integration. The underpinning for an organization's use of the proposed middleware is the ability to discover existing data sources, to have a uniform access to them regardless their heterogeneity and their location and to save time in the development of new business applications by enabling the integration of existing data sources through service composition.

The DSM consists of three main components: the Data-Provider, the Data-Discovery and the Data-Consumer. The Data Provider enables the users to export and publish their data sources as a data-services in a UDDI registry. The Data Discovery component allows the peers to discover published data-services. The Data Consumer enables the peer to invoke operations of the discovered services. The invocation of an operation of data-service will lead to the execution of appropriate data manipulation statement on the corresponding back-end data source. Moreover, the Data consumer allows the users to integrate (virtual integration) data from heterogeneous data sources by enabling the user to compose new data-services that aggregates operations of different data-services. The execution of the composite data-services could be done in sequential or in parallel mode.

The DSM solves the heterogeneity between data sources by implementing an abstract data layer called DSL which provides uniform access to the data sources. Furthermore, it adopts a standard platform-independent technology (Web-services technology) to export those data sources as data-services. DSM meets the current demands of data sharing in a P2P environment by providing a set of well-defined, ready-made and easy-to-use services that allow non-expert users to publish, discover and use data-services without writing any additional code and with less effort.

For the time being, we assume that the schemes of the data sources are stable and do not change. Therefore, if changes are made to these schemes, the corresponding data-services are no more appropriate and require to be updated. Changing these services may cause some peers to crash. We intend to support a multi-versioning system that ensures service availability for peers, who already derived new services from those updated ones. We intend also to introduce a caching mechanism into DSM in order to reduce the execution time of users' requests and increase the data availability when back-end data sources experience some deficiencies.

We claim:

1. A device for accessing and sharing remote, heterogeneous and autonomous peer-to-peer (P2P) data sources comprising a general purpose computer with a Graphical User Interface with an Application Programming Interface, the Application Programming Interface comprising a Profile Publisher, Data Provider, Data Discovery, Data Consumer, Data Service Layer, Data Service Composition Engine, UDDI Registry Client, and SOAP Message Handler.
